(19) United States
(12) Patent Application Publication
(10) Pub. No.: US 2020/0082307 A1
(43) Pub. Date: Mar. 12, 2020

(54) REAL-TIME MATCHING OF USERS TO ENTERPRISE INTERFACES AND ARTIFACTS

(71) Applicant: SAP SE, Walldorf (DE)

(72) Inventor: Oren Haze, Kfar Saba (IL)

(21) Appl. No.: 16/126,144

(22) Filed: Sep. 10, 2018

(51) Int. Cl. G06Q 10/06; G06N 99/00; G06N 5/02

(52) U.S. Cl. CPC G06Q 10/0631; G06N 5/022; G06N 99/005

(57) ABSTRACT

User information for a particular user is accessed. Application interface and artifact information for application interfaces and artifacts that are available in an organization of the particular user is accessed. One or more pattern matches are determined between the user information and the application interface and artifact information. One or more interface or artifact recommendations are generated based on the determined one or more pattern matches. The one or more interface or artifact recommendations are provided.

### CROSS-REFERENCE TO RELATED APPLICATIONS

This application is a co-pending application of, and filed in conjunction with, U.S. patent application Ser. No. ______, filed on, entitled “REAL-TIME MATCHING OF USERS AND APPLICATIONS”, (Attorney Docket No. 22135-1255001/180425US01) and U.S. patent application Ser. No. ______, filed on ______, entitled “RECOMMENDATIONS AND FRAUD DETECTION BASED ON DETERMINATION OF A USER'S NATIVE LANGUAGE”, (Attorney Docket No. 22135-1259001/180518US01); the entire contents of each which are incorporated herein by reference.

### BACKGROUND

A software artifact can be produced during software development. Artifacts such as use cases, class diagrams, other models, and requirements/design documents can be used to describe software functions, architecture, and design. Other software artifacts can describe a software development process.

An Application Programming Interface (API) is a specification of a set of one or more interfaces to a software application or computing system. An API can have a design-time aspect, in that interfaces can be documented to describe their purpose, inputs, outputs, and potential side effects. An API can also have a runtime aspect, in that an API can refer to callable or evocable functions or objects, which provide a runtime interface, to a target computing system providing the API, to another computing system that wants to interface with the target computing system.

### SUMMARY

The present disclosure describes real-time matching of users to enterprise interfaces and artifacts.

In an implementation, user information for a particular user is accessed. Application interface and artifact information for application interfaces and artifacts that are available in an organization of the particular user is accessed. One or more pattern matches are determined between the user information and the application interface and artifact information. One or more interface or artifact recommendations are generated based on the determined one or more pattern matches. The one or more interface or artifact recommendations are provided.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, a recommendation engine can perform real-time identifying, recommending, optimizing, personalizing, and suggesting ways of using enterprise interfaces and artifacts. Second, a recommendation engine can identify missing interface and artifact functionality, by examining user behavior, and recommend implementation of the identified functionality. Third, a recommendation computing system can create real-time and personalized interface and artifact recommendations for specific industries, verticals, or lines of business. Fourth, a knowledge base of user and interface/artifact information can be created, enabling interface and artifact recommendation and, additionally, analysis of user interface/artifact usage, and user and interface/artifact landscapes. Fifth, a recommendation computing system can self-learn and improve recommendations over time. Sixth, a recommendation computing system can generate specific recommendations for a large number of disparate users, based on dynamic user-information and dynamic interface/artifact information knowledge bases, based on a current context and knowledge base state for each respective request.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a prior art computing system in which enterprise interfaces and artifacts are not recommended, according to an implementation of the present disclosure.

FIG. 2 is a block diagram illustrating an example of a computing system in which an intelligent recommender recommends enterprise interfaces and artifacts to users in real-time, according to an implementation of the present disclosure.

FIG. 3 is a block diagram illustrating an example of a computing system for recommending enterprise interfaces and artifacts, according to an implementation of the present disclosure.

FIG. 4 is a flowchart illustrating an example of a computer-implemented method for real-time matching of users to enterprise interfaces and artifacts, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes real-time matching of users to enterprise interfaces and artifacts, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

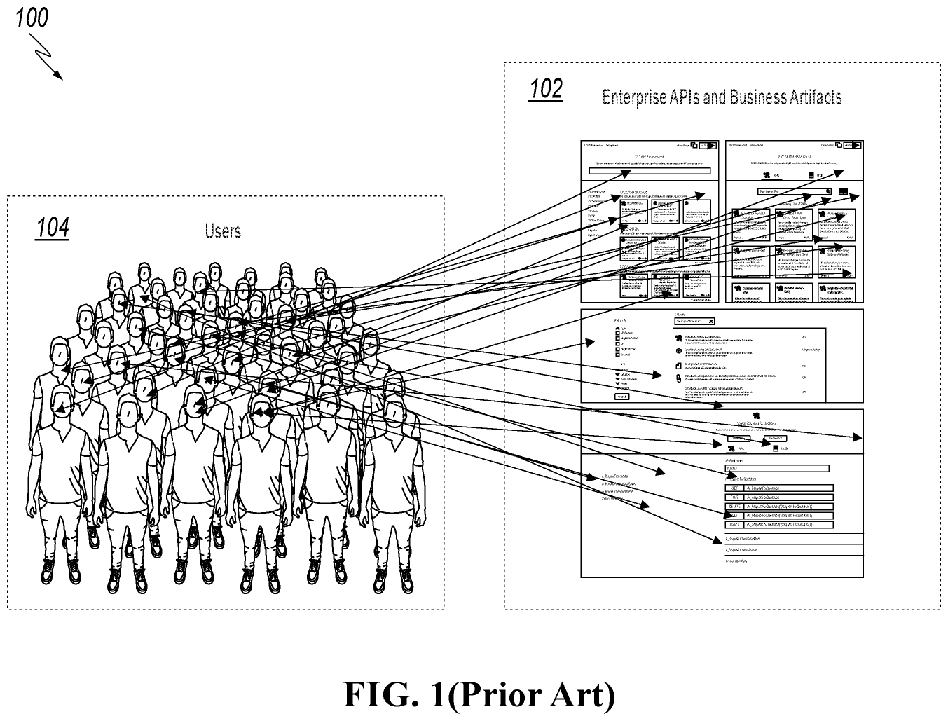

FIG. 1 is a block diagram illustrating an example of a prior art computing system 100 in which enterprise interfaces and artifacts are not recommended, according to an implementation of the present disclosure. An enterprise interface and artifact landscape 102 for a large software provider can be complex. A large software provider can provide thousands of different interfaces and artifacts. The software provider can provide interfaces and artifacts related to one or more enterprise software applications. The applications can come from multiple back-ends and platforms. The applications can include business intelligence, customer relationship management, human resource management, enterprise resource management, business management, business to business (B2B), content management, manufacturing resource management, financial management, e-commerce, and supply chain management software, as some examples.

Interfaces can include APIs (Application Programming Interfaces), available services, and other types of interfaces. Artifacts can include programs, databases, data files, use cases, class diagrams, design models, requirements documents, design documents, project plans, business cases, risk assessments, software build executables, test plans, walkthrough documents, test suites, code libraries, testing harnesses, software documentation, and other artifacts. Many interfaces and artifacts can be complex, with complex functionality that may require prerequisite knowledge for effective use.

The interface and artifact landscape 102 in an organization can be frequently changing. New interfaces and artifacts can be added. Existing interfaces and artifacts can become obsolete and be retired or deprecated. In-use interfaces and artifacts can change. Functionality provided by an interface can be added, changed, or removed. A change in functionality can result in a change in prerequisite knowledge needed for effective use of an interface.

A user landscape 104 in a large organization can also be complex. Users in the user landscape 104 can be developers, testers, analysts, administrators, and other types of users who may have a need to use software interfaces or artifacts. New users can be added to an organization upon being hired. A given user's role within the organization can change, such as from tester to developer. For example, a user can have a change in job function, a change in department, or a change in relationships with other coworkers. A user's platform preferences can also change, as well as a user's assignment to different types of projects, which can require different tools or associations with different platforms. A user continues, over time, to build upon an interface/artifact experience and training history.

There may be, in a given organization, a major lack of knowledge and efficiency when a user needs to decide when and what interface or artifact to use. Unplanned, unsophisticated, rushed, or random interface or application choosing may be inefficient and can cause damage to an organization itself (for example, due to revenue loss, fines, brand damage, or legal implications).

It can be challenging for a user to keep up to date regarding the latest and current interfaces and artifacts that are available to and applicable to the user's needs. Frequent interface and artifact changes and a large number of available interfaces and artifacts can dramatically challenge users on a day-to-day basis. An end user may not know which interfaces and artifacts are available and which set of interfaces and artifacts best suits the user's needs, at a given point-in-time and in a given context. The user can be unaware that a given interface or artifact exists, since it may be difficult to locate all currently available interfaces and artifacts.

To solve the previously described challenges, a recommendation computing system can be used for real-time matching of users to enterprise interfaces and artifacts. A typical situation that can arise when developing software products or services is that there can be different ways to implement the software products or software architecture. Therefore, to perform specific functionality, a user/developer could use different APIs or artifacts. The recommendation computing system can recommend the most relevant/suitable APIs or artifacts in a relevant context in order for the user/developer to be effective and efficient, to strengthen the quality of the software products and a brand associated with the software products, and to reduce unnecessary software development investments.

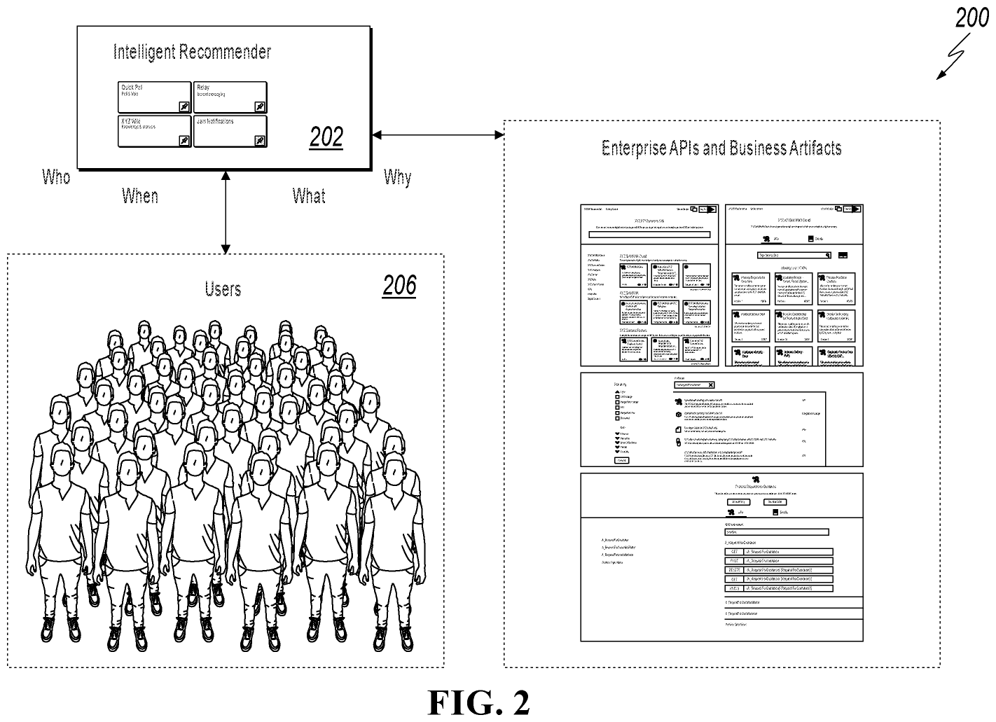

FIG. 2 is a block diagram illustrating an example of a computing system 200 in which an intelligent recommender 202 recommends interfaces and artifacts to users in real-time, according to an implementation of the present disclosure. The intelligent recommender 202 can recommend specific interfaces and artifacts 204 to particular users 206 according to a respective user's current context and historical data, by performing real-time, personalized, intelligent matching between the users 206 and the interfaces and artifacts 204. In some implementations, the intelligent recommender 202 can make recommendations based on one or more algorithms that are configured to recommend a right application, to the right user, at the right time and place (for example, “who”, “when”, “what”, and “why” recommendations). Even though user and interface/artifact information can be frequently changing, the intelligent recommender 202 can perform, at a given point-in-time, automatic matching of users 206 to interfaces and artifacts 204 in a given context, such as a given user's location (such as a work site) and current information retrieved at the given point-in-time.

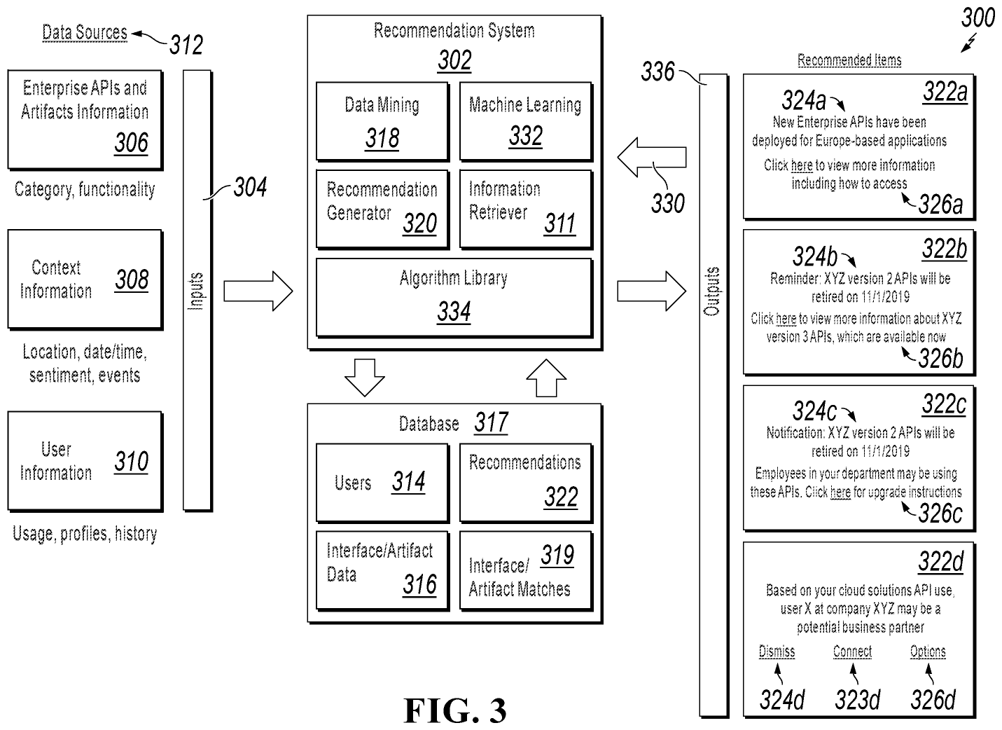

FIG. 3 is a block diagram illustrating an example of a computing system 300 for recommending interfaces and artifacts, according to an implementation of the present disclosure. A recommendation computing system 302 can obtain a variety of inputs 304. Inputs 304 can include interface/artifact information 306, context information 308, and user information 310. Some or all of the inputs 304 can be obtained by an information retriever 311. In some implementations, the information retriever 311 can periodically (for example, every minute, hour, or day) request interface/artifact information 306, context information 308, or user information 310 from a list of known data sources 312. As another example, the information retriever 311 can automatically receive interface/artifact information 306, context information 308, or user information 310 from the data sources 312. For example, the data sources 312 can be configured to periodically provide interface/artifact information 306, context information 308, or user information 310. As another example, the data sources 312 can be configured to provide interface/artifact information 306 or user information 310 when interface/artifact information 306 or user information 310 change in a data source 312, due to new, changed, or deleted information. In addition to obtaining external interface/artifact information 306, context information 308, or user information 310, the recommendation computing system 302 can obtain user information 314 or interface/artifact data 316 that is stored internally in a database 317 by the recommendation computing system 302 or by another computing system at a same organization as the recommendation computing system 302.

Interface/artifact information 306 can include interface and artifact metadata that can include interface and artifact categories, descriptions, required prerequisite knowledge, required prerequisite training, targeted user role, needed permissions, pricing, interface/artifact functionality descriptions, interface/artifact options, interface/artifact implementation requirements (platforms, versions, interfaces to other services), code-snippets, and other information.

User information 310 can include organizational data, demographic data, interface/artifact usage and other user activity information, user roles, user profile information, or user preferences (such as, for types of interfaces or platforms). Interface/artifact usage information can include usage information for some or all interfaces/artifacts used by a given user, including installation, use, and removal of interfaces/artifacts by the user within the organization, and interface/artifact feature utilization. User information 310 can include data stored for a user in an organization, such as tasks assigned to the user (and completion status), a user's calendar and scheduled events, and a user's relationships to other users (and user information for those other related users). User information can include a user's role to particular current and historical projects, and technologies (such as, programming languages, databases, platforms, or methodologies) used for the projects. User information 310 received by the recommendation computing system 302 can be information for which the recommendation computing system 302 has been permitted to obtain, by a particular user, an organization, or an interface/artifact owner.

Context information 308 can include context data associated with obtained interface/artifact information 306 or user information 310, such as a date, time, or location of a data capture. As another example, context information 308 can represent current information for a user, such as a user's current location, or a current date and time, such as date and time at which next recommendation(s) can be generated. Date or time information can represent particular date or time periods, such as afternoon-time, morning-time, weekday, weekend, a particular season, end-of-quarter, or end-of-year. For example, location information can correspond to a user's work location or home location, a city, a state, or a country.

Other context information 308 can include sentiment information or event information. In some implementations, event information can include a reminder of a due date, a request to develop or enhance new functionality (which may require the use of APIs or artifacts), or a notification regarding new, changed, or deleted APIs or artifacts that may be available (or unavailable) to a user. In some implementations, sentiment information can include positive or negative information about a user's use or preference for various APIs. In some cases, a user's current or past use of certain APIs or artifacts or types of APIs or artifacts can be viewed as a positive endorsements of those APIs or artifacts. Similarly, a user's stopping of use of a particular API or artifact due to deploying a replacement API or artifact can be viewed as negative sentiment. In some implementations, positive or negative reviews of APIs or artifacts can also be included in the sentiment information.

Obtained interface/artifact information 306 and user information 310 can be stored by the recommendation computing system 302, as user information 314 or interface/artifact data 316, respectively. Context information 308 that may have been associated with the interface/artifact information 306 or user information 310 can be stored in the database 317 linked to respective associated data. A data mining component 318 can analyze the user information 314 and interface/artifact data 316 to determine pattern matches between the user information 314 and the interface/artifact data 316, for purposes of generating one or more interface/artifact recommendations for one or more users. In some implementations, a pattern match can exist where user information 314 for a user matches interface/artifact data 316 for an interface or artifact the user has previously used or for an interface/artifact that the user has not used before.

For example, user information 314 can indicate that a user is assigned to a project that is related to certain types of functionality. In some implementations, the data mining component 318 can determine one or more interfaces or artifacts that may be related to the type of functionality used with the project. As another example, user information 314 may indicate that a user currently uses interfaces or artifacts that are related to certain types of functionality. In some implementations, the data mining component 318 can determine one or more other interfaces or artifacts, such as newer interfaces or artifacts, which may be able to be used by the user to perform the same functionality in a more efficient manner.

The data mining component 318 can determine interfaces or artifacts used by users that are going to be retired or eliminated at a later date. The data mining component 318 can identify replacement interfaces or artifacts that include the same functionality, or other interfaces or artifacts that have been previously identified as replacement interfaces or artifacts. In some implementations, replacement interface/artifact information can be included in a subsequently generated recommendation, to be presented to users who are still using the to-be-retired interfaces or artifacts.

Interface/artifact recommendations can be based on a user's role within an organization. A user in a given role may need to perform certain tasks or have access to certain types of applications. Role-specific recommendations can be provided for various roles, such as developers, testers, project managers, technology managers, or administrators, to name a few examples. The data mining component 318 can determine user information 314 for users that are similar to a given user. For example, interface/artifact usage information for users with a same role or same or similar project assignment can be identified. The data mining component 318 can identify, for a given user, interfaces or artifacts that are used by users similar to the user.

The data mining component 318 can match interfaces and artifacts to users based at least in part on context information associated with the user. For example, user information 314 can include current or recent performance information and specifications for computing device(s) used by the user. The data mining component 318 can identify interfaces or artifacts that may achieve acceptable performance or may be installable or usable on the user's current computing devices, given the current performance and specifications of the computing devices. In some implementations, the data mining component 318 can also identify interfaces/artifacts which could be used by the user if the user upgraded or changed specifications of their computing device(s). The data mining component 318 can determine interfaces or artifacts that can be used or available at a current location or site at which the user is currently located.

Determined interface/artifact matches 319 to users can be stored in the database 317, and used by a recommendation generator 320 to generate one or more interface/artifact recommendations 322, such as recommendations 322a, 322b, 322c, and 322c (details of which can also be stored in the database 317). Recommendations 322a, 322b, 322c, and 322c are described in more detail in following paragraphs. A recommendation 322 can include a description of the recommended interface/artifact and why the interface/artifact is being recommended to a particular user. Recommendations 322 can be real-time and personalized recommendations for users in specific industries, verticals, or lines of business.

Recommendations 322 can be a reminder for a user to use an interface or artifact which a user has previously used. Recommendations 322 can be for interfaces or artifacts which a user has configured, but not used, or an interface or artifact for which a user has access (permitted to use, able to access). As another example, a recommendation 322 can be for an interface or artifact for which a user does not currently have access, but for which a user can obtain access. The recommendation 322 can include a description of how the user can obtain access to the recommended interface or artifact. For example, a recommendation 322 can include information regarding which administrator to contact to get access to the recommended interface or artifact. As another example, a recommendation 322 can include a download link, a service endpoint, information on parameters that can be used to configure the interface or artifact, including one-time and per-use configuration.

In some implementations, presented recommendations can be presented in different channels, such as in an interface/artifact search application, an API management application, an API catalog, an IDE (Integrated Development Environment), a development workbench, a project dashboard, email, on various types of user devices, including mobile devices, desktop devices, or other computing devices or messaging platforms. In general, recommendations for an interface or artifact can be presented to a user while a user is using a particular application, while in a certain location, at a next login time, or upon other scheduling.

The data mining component 318, information retriever 311, and recommendation generator 320 can perform processing at various times and in response to various triggers. In general, processing by the recommendation computing system 302 can be ongoing, either periodic or event-driven, to account for potentially frequent changes in interface/artifact information 306 and user information 310. Recommendation computing system 302 processing can be performed periodically, such as every minute, every hour, every day, or in response to changed data or newly received data. As described previously, a large organization may have many thousands of users and many thousands of interfaces and artifacts, resulting in dynamic interface/artifact information 306 and user information 310 data sets. Without frequent interface/artifact recommendation generation, users may not be using interfaces or artifacts best suited to their needs or the needs or an associated organization. Recommendation computing system 302 processing can be performed in batch, such as by periodically obtaining interface/artifact information 306 and user information 310 for all known interfaces, artifacts, and users, and automatically generating new recommendations based on a current state of the database 317. As another example, the recommendation computing system 302 may generate recommendations for particular users based on activities performed by a given user, such as the user logging in, starting a dashboard or other application, or being at a particular location.

As a specific example, a software provider may have deployed a new set of enterprise APIs for a suite of offerings offered in a particular market, such as Europe. The data mining component 318 can determine, based on user role and project affiliation, which certain users may have use for the new APIs but have not yet used the new APIs. The recommendation generator 320 can generate the recommendation 322a for presentation to the users who may find the new APIs relevant who have not yet used the new APIs. The recommendation 322a includes a reason 324a for the recommendation 322a and a suggestion to obtain more information about the new APIs, including a link 326a that provides access to more information and API access instructions.

As another example, a software provider may have deployed a new version of a set of APIs. A prior version of the APIs may be offered for a limited time but may be marked as deprecated. The data mining component 318 can determine, based on user activity information, which users have used or inquired about the deprecated APIs within a recent time period. The recommendation generator 320 can generate the recommendation 322b for presentation to the users who have recently used or inquired about the deprecated APIs. The recommendation 322b includes a reason 324b for the recommendation 322b and a suggestion to obtain more information about the new APIs, including a link 326b that provides access to more information and API access instructions for the new APIs. The recommendation 322b can be presented automatically in response to user use or inquiry of deprecated APIs or can be scheduled as continual reminders, up to a retire date, for users who had previously used or inquired about the deprecated APIs. The recommendation 322b delivery can be tailored so as to be shown to relevant users. For example, user activity information can indicate de-installation of the deprecated APIs by certain users, or non-use of the deprecated APIs for a certain number of consecutive days after previous use, which can indicate certain users are no longer using the deprecated APIs. Those certain users who may no longer need to see the recommendation 322b can be excluded from delivery of the recommendation 322b. Similar processing can occur for deprecated artifacts.

The data mining component 318 can analyze other user information and connections. For example, the data mining component can determine managers of employees who have recently used or inquired about the deprecated APIs. The recommendation generator 320 can generate the recommendation 322c as a notification to the manager that employees in the manager's department may be using deprecated APIs. A reason 324c for the recommendation can be presented, along with a suggestion to follow a link 326c to get upgrade instructions. The manager can select the link 326c to view the upgrade instructions and to forward the recommendation (and upgrade instructions) to relevant employees.

In some implementations, the recommendation generator 320 can determine when a user/developer is viewing specific API or artifact documentation, such as in an API/artifact browser tool or catalog, and leverage an opportunity to offer relevant recommendation(s) regarding APIs, artifacts, or other documentation that are relevant to the API or artifact being browsed (such as, similar, potential substitutes, or otherwise relevant products or services). The recommendations can be presented within the API/artifact browser tool or catalog.

In yet another example, a software provider can provide a cloud solution to manage customer sales, customer service, and marketing activities for organizations. The data mining component 318 can analyze user information including company type, user role, and past interface and artifact use related to the cloud solution. The data mining component 318 identifies matches between users who may be potential business and integration/solution partners. The recommendation engine can generate a recommendation 322d that can be presented to a matched user, as an invitation to connect with the other matched user (such as using a link 323d). The user can dismiss the recommendation 322d by clicking a link 324d. The user can tailor such recommendations (for example, to create broader or narrower matching, or to opt out of such matching) by selecting an options link 326d.

After recommendations 322a, 322b, 322c, and 322d and other recommendations are presented, feedback 330 can be provided to the recommendation computing system 302. Feedback 330 can include indications of whether recommendations were acted upon, how long to respond, or whether presented recommendations 322a, 322b, 322c, or 322d were dismissed without being acted upon. For recommendations for which a recommended interface/artifact was installed or used, the feedback 330 can include usage information for the acted-upon application interface/artifact so that the recommendation computing system 302 knows how much (if any) a recommended application interface/artifact is used after selection of a recommendation. The feedback 330 can be used by a machine-learning engine 332 to tailor future recommendations.

The recommendation generator 320 can be configured to consider multiple type of pattern matches and use various algorithms to determine which recommendations to generate. Algorithm outputs can be aggregated to determine final recommendations. Each type of pattern match can have a corresponding weight. Weights for types or pattern matches or algorithms can be adjusted based on received feedback 330.

For example, certain types of recommendations (such as, formats or channels) that are acted upon at a higher-frequency than other types of recommendations can be used more often than recommendation types that are acted upon less-frequently. As another example, if less than a certain predefined percentage of users accept a recommendation for a particular application, recommendations for that application can be reduced or eliminated in the future. As a specific example, if less than two percent of users act upon a recommendation for a new email application, the machine-learning engine 332 can send information to the recommendation generator 320 so that the email application is not recommended (or recommended even less frequently or only recommended based on particular criteria) in the future. Conversely, if recommendations for a new human resources application are accepted at a rate of 90%, the machine-learning engine 332 can send information to the recommendation generator 320 so that the human resources application is recommended to more users more often.

The data mining component 318, the information retriever 311, the recommendation generator 320, or the machine-learning engine 332 can use an algorithm library 334 for processing. For example, pattern-matching algorithms, machine-learning algorithms, or other mathematical algorithms can be accessed by recommendation computing system 302 components from the algorithm library 334.

Other types of outputs 336 can be produced by the recommendation computing system 302. For example, the recommendation computing system 302 can expose user information 314, interface/application data 316, recommendations 322, and interface/artifact matches 319 to privileged users, for analysis and understanding of user and interface/artifact landscapes and recommendation history. In some implementations, stored recommendations 322 can include information on recommendation acceptance rate. Exposed information from the database 317 can be provided in report or data feed form (for analyst viewing or processing by computing system(s)).

The recommendation computing system 302 can analyze user behavior information to come up with insights that can identify application functionality that may be missing from the application landscape. The recommendation computing system 302 can generate recommendations for new application functionality (for example, to be presented to administrators or information technology personnel). For example, the recommendation computing system 302 can recognize a pattern of API or artifact use that is common among developers or users. For example, the recommendation computing system 302 can recognize that multiple developers use a same set of APIs when reading a data record from a database (for example, a first call to connect to the database, a second call to find a particular record, and a third call to retrieve an identified record). The recommendation computing system 302 can recognize this usage pattern and recommend combining the multiple calls into a single API call that performs the three operations in response to the single call.

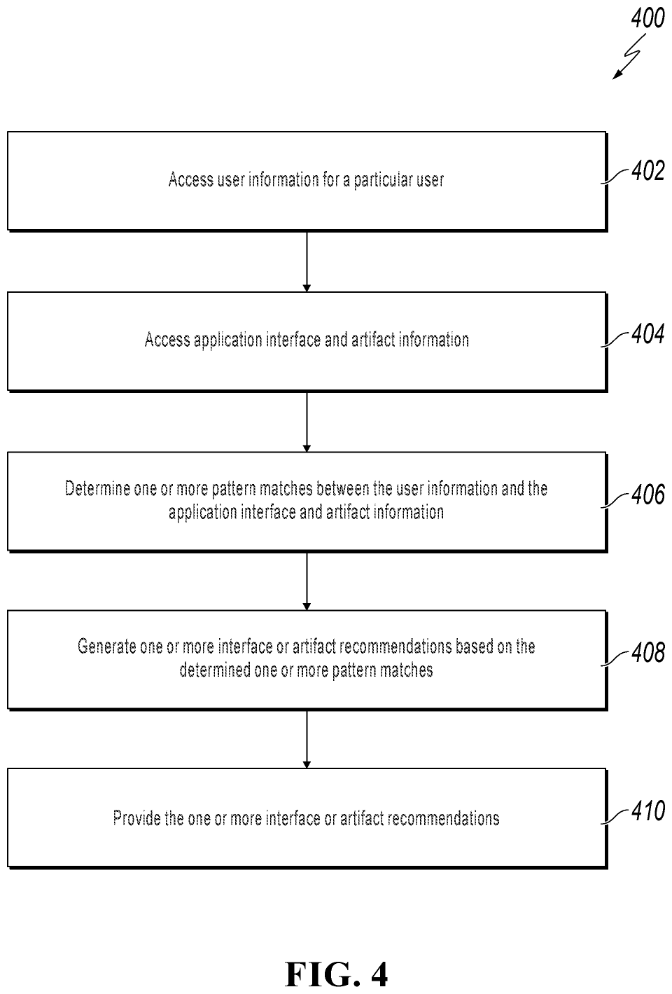

FIG. 4 is a flowchart illustrating an example of a computer-implemented method 400 for real-time matching of users to interfaces and artifacts, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

At 402, user information for a particular user is accessed. User information can include one or more of organizational data for the user, project participation data, demographic data, interface/artifact usage information, a user role for the user, user profile information, user activity data, user preferences, a current location of the user, or a current time at which a recommendation can be presented to the user. From 402, method 400 proceeds to 404.

At 404, application interface and artifact information is accessed for interfaces and artifacts that are available in an organization of the particular user. Interfaces can include enterprise APIs or service interfaces. Artifacts can include programs, databases, use cases, class diagrams, design models, requirements documents, design documents, project plans, business cases, risk assessments, software build executables, test plans, walkthrough documents, test suites, code libraries, testing harnesses, or software documentation. Interface and artifact information can include one or more of an interface/artifact category, an interface/artifact description, interface/artifact knowledge prerequisite information, interface/artifact training prerequisite information, interface artifact functionality, interface/artifact runtime requirements, interface/artifact configuration information, or interface/artifact permission requirements. From 404, method 400 proceeds to 406.

At 406, one or more pattern matches between the user information and the application interface and artifact information are determined. A pattern match can be a match between the user information and a predefined pattern relating to interface/artifact data or a match between interface/artifact information and a predefined pattern relating to user information. From 406, method 400 proceeds to 408.

Determining the one or more pattern matches can include determining an interface or artifact to which the user has access, determining an interface or artifact that matches historical application usage for the user, or determining an interface or artifact that matches a role of the user, to name a few examples. As another example, determining the one or more pattern matches can include determining an interface or artifact that matches some of the user information, with the user lacking knowledge or training to use the interface or artifact, and an identification of the lacked knowledge or training and a determination of how to obtain the lacked knowledge or training.

At 408, one or more interface or artifact recommendations are generated based on the determined one or more pattern matches. The one or more interface or artifact recommendations can be generated in response to a trigger, such as a change in user information, a change in interface or artifact information, or a start of a periodic interval at which to automatically process the user information and the application interface and artifact information. From 408, method 400 proceeds to 410.

At 410, the one or more interface or artifact recommendations are provided. For example, interface and artifact recommendation(s) can be presented to the user in a user interface. After 410, method 400 stops.

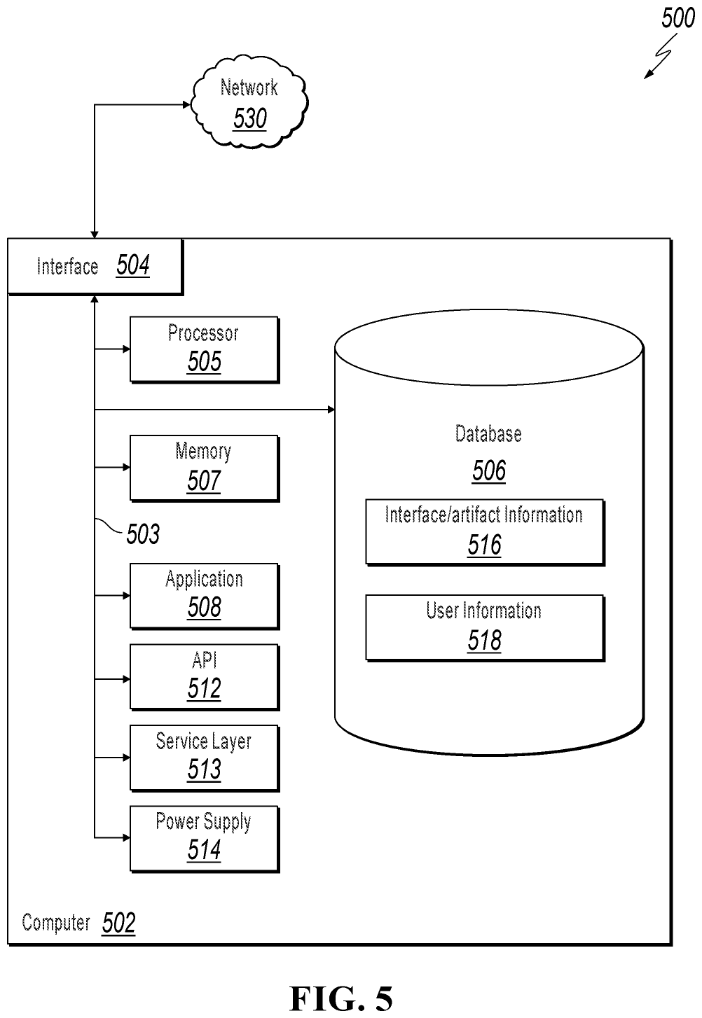

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, System 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. As illustrated, the Database 506 holds the previously described interface/artifact information 516 and user information 518.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method, comprises: accessing user information for a particular user; accessing application interface and artifact information for application interfaces and artifacts that are available in an organization of the particular user; determining one or more pattern matches between the user information and the application interface and artifact information; generating one or more interface or artifact recommendations based on the determined one or more pattern matches; and providing the one or more interface or artifact recommendations.

The foregoing and other described implementations can each, optionally, include one or more of the following features:

A first feature, combinable with any of the following features, wherein the user information includes one or more of organizational data for the user, demographic data, interface or artifact usage information, a user role for the user, project participation data, user profile information, user activity data, user preferences, a current location of the user, or a current time at which a recommendation can be presented to the user.

A second feature, combinable with any of the previous or following features, wherein the application interface and artifact information includes one or more of an interface or artifact category, an interface or artifact description, interface or artifact knowledge prerequisite information, interface or artifact training prerequisite information, interface or artifact functionality, interface or artifact runtime requirements, interface or artifact configuration information, or interface or artifact permission requirements.

A third feature, combinable with any of the previous or following features, wherein at least one pattern match is a match between the user information and a predefined pattern relating to application interface and artifact data.

A fourth feature, combinable with any of the previous or following features, wherein at least one pattern match is a match between application interface and artifact information and a predefined pattern relating to user information.

A fifth feature, combinable with any of the previous or following features, wherein the one or more interface or artifact recommendations are generated in response to a trigger.

A sixth feature, combinable with any of the previous or following features, wherein the trigger comprises one of a change in user information, a change in interface information, a change in artifact information, or a start of a periodic interval at which to automatically process the user information and the application interface and artifact information.

A seventh feature, combinable with any of the previous or following features, further comprising storing the one or more pattern matches.

An eighth feature, combinable with any of the previous or following features, further comprising: receiving feedback related to one or more provided interface or artifact recommendations; and adjusting a pattern recognition engine to improve generation of future interface or artifact recommendations.

A ninth feature, combinable with any of the previous or following features, wherein determining one or more pattern matches comprises determining an application that matches historical interface or artifact usage for the user.

A tenth feature, combinable with any of the previous or following features, wherein determining one or more pattern matches comprises determining an interface or artifact that matches a role of the user.

An eleventh feature, combinable with any of the previous or following features, wherein the application interfaces are enterprise application programming interfaces.

A twelfth feature, combinable with any of the previous or following features, wherein the application artifacts include one or more of a database, an executable program, a data file, a configuration file, a use case, a class diagram, a design model, a requirements document, a design document, a project plan, a business case, a risk assessment, a software build executable, a test plan, a walkthrough document, a test suite, a code library, a testing harnesses, or software documentation.

In a second implementation, a non-transitory, computer-readable medium stores one or more instructions executable by a computer system to perform operations comprising: accessing user information for a particular user; accessing application interface and artifact information for application interfaces and artifacts that are available in an organization of the particular user; determining one or more pattern matches between the user information and the application interface and artifact information; generating one or more interface or artifact recommendations based on the determined one or more pattern matches; and providing the one or more interface or artifact recommendations.

The foregoing and other described implementations can each, optionally, include one or more of the following features:

A first feature, combinable with any of the following features, wherein the user information includes one or more of organizational data for the user, demographic data, interface or artifact usage information, a user role for the user, project participation data, user profile information, user activity data, user preferences, a current location of the user, or a current time at which a recommendation can be presented to the user.

A second feature, combinable with any of the previous or following features, wherein the application interface and artifact information includes one or more of an interface or artifact category, an interface or artifact description, interface or artifact knowledge prerequisite information, interface or artifact training prerequisite information, interface or artifact functionality, interface or artifact runtime requirements, interface or artifact configuration information, or interface or artifact permission requirements.

A third feature, combinable with any of the previous or following features, wherein at least one pattern match is a match between the user information and a predefined pattern relating to application interface and artifact data.

A fourth feature, combinable with any of the previous or following features, wherein at least one pattern match is a match between application interface and artifact information and a predefined pattern relating to user information.

A fifth feature, combinable with any of the previous or following features, wherein the one or more interface or artifact recommendations are generated in response to a trigger.

A sixth feature, combinable with any of the previous or following features, wherein the trigger comprises one of a change in user information, a change in interface information, a change in artifact information, or a start of a periodic interval at which to automatically process the user information and the application interface and artifact information.

A seventh feature, combinable with any of the previous or following features, further comprising storing the one or more pattern matches.

An eighth feature, combinable with any of the previous or following features, further comprising: receiving feedback related to one or more provided interface or artifact recommendations; and adjusting a pattern recognition engine to improve generation of future interface or artifact recommendations.

A ninth feature, combinable with any of the previous or following features, wherein determining one or more pattern matches comprises determining an application that matches historical interface or artifact usage for the user.

A tenth feature, combinable with any of the previous or following features, wherein determining one or more pattern matches comprises determining an interface or artifact that matches a role of the user.

An eleventh feature, combinable with any of the previous or following features, wherein the application interfaces are enterprise application programming interfaces.

A twelfth feature, combinable with any of the previous or following features, wherein the application artifacts include one or more of a database, an executable program, a data file, a configuration file, a use case, a class diagram, a design model, a requirements document, a design document, a project plan, a business case, a risk assessment, a software build executable, a test plan, a walkthrough document, a test suite, a code library, a testing harnesses, or software documentation.

In a third implementation, A computer-implemented system, comprises one or more computers and one or more computer memory devices interoperably coupled with the one or more computers and having tangible, non-transitory, machine-readable media storing one or more instructions that, when executed by the one or more computers, perform one or more operations comprising: accessing user information for a particular user; accessing application interface and artifact information for application interfaces and artifacts that are available in an organization of the particular user; determining one or more pattern matches between the user information and the application interface and artifact information; generating one or more interface or artifact recommendations based on the determined one or more pattern matches; and providing the one or more interface or artifact recommendations.

The foregoing and other described implementations can each, optionally, include one or more of the following features:

A first feature, combinable with any of the following features, wherein the user information includes one or more of organizational data for the user, demographic data, interface or artifact usage information, a user role for the user, project participation data, user profile information, user activity data, user preferences, a current location of the user, or a current time at which a recommendation can be presented to the user.

A second feature, combinable with any of the previous or following features, wherein the application interface and artifact information includes one or more of an interface or artifact category, an interface or artifact description, interface or artifact knowledge prerequisite information, interface or artifact training prerequisite information, interface or artifact functionality, interface or artifact runtime requirements, interface or artifact configuration information, or interface or artifact permission requirements.

A third feature, combinable with any of the previous or following features, wherein at least one pattern match is a match between the user information and a predefined pattern relating to application interface and artifact data.

A fourth feature, combinable with any of the previous or following features, wherein at least one pattern match is a match between application interface and artifact information and a predefined pattern relating to user information.

A fifth feature, combinable with any of the previous or following features, wherein the one or more interface or artifact recommendations are generated in response to a trigger.

A sixth feature, combinable with any of the previous or following features, wherein the trigger comprises one of a change in user information, a change in interface information, a change in artifact information, or a start of a periodic interval at which to automatically process the user information and the application interface and artifact information.

A seventh feature, combinable with any of the previous or following features, further comprising storing the one or more pattern matches.

An eighth feature, combinable with any of the previous or following features, further comprising: receiving feedback related to one or more provided interface or artifact recommendations; and adjusting a pattern recognition engine to improve generation of future interface or artifact recommendations.

A ninth feature, combinable with any of the previous or following features, wherein determining one or more pattern matches comprises determining an application that matches historical interface or artifact usage for the user.

A tenth feature, combinable with any of the previous or following features, wherein determining one or more pattern matches comprises determining an interface or artifact that matches a role of the user.

An eleventh feature, combinable with any of the previous or following features, wherein the application interfaces are enterprise application programming interfaces.

A twelfth feature, combinable with any of the previous or following features, wherein the application artifacts include one or more of a database, an executable program, a data file, a configuration file, a use case, a class diagram, a design model, a requirements document, a design document, a project plan, a business case, a risk assessment, a software build executable, a test plan, a walkthrough document, a test suite, a code library, a testing harnesses, or software documentation.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
accessing user information for a particular user;
accessing application interface and artifact information for application interfaces and artifacts that are available in an organization of the particular user;
determining one or more pattern matches between the user information and the application interface and artifact information;
generating one or more interface or artifact recommendations based on the determined one or more pattern matches; and
providing the one or more interface or artifact recommendations.

2. The computer-implemented method of claim 1, wherein the user information includes one or more of organizational data for the user, demographic data, interface or artifact usage information, a user role for the user, project participation data, user profile information, user activity data, user preferences, a current location of the user, or a current time at which a recommendation can be presented to the user.

3. The computer-implemented method of claim 1, wherein the application interface and artifact information includes one or more of an interface or artifact category, an interface or artifact description, interface or artifact knowledge prerequisite information, interface or artifact training prerequisite information, interface or artifact functionality, interface or artifact runtime requirements, interface or artifact configuration information, or interface or artifact permission requirements.

4. The computer-implemented method of claim 1, wherein at least one pattern match is a match between the user information and a predefined pattern relating to application interface and artifact data.

5. The computer-implemented method of claim 1, wherein at least one pattern match is a match between application interface and artifact information and a predefined pattern relating to user information.

6. The computer-implemented method of claim 1, wherein the one or more interface or artifact recommendations are generated in response to a trigger.

7. The computer-implemented method of claim 6, wherein the trigger comprises one of a change in user information, a change in interface information, a change in artifact information, or a start of a periodic interval at which to automatically process the user information and the application interface and artifact information.

8. The computer-implemented method of claim 1, further comprising storing the one or more pattern matches.

9. The computer-implemented method of claim 1, further comprising:
receiving feedback related to one or more provided interface or artifact recommendations; and
adjusting a pattern recognition engine to improve generation of future interface or artifact recommendations.

10. The computer-implemented method of claim 1, wherein determining one or more pattern matches comprises determining an application that matches historical interface or artifact usage for the user.

11. The computer-implemented method of claim 1, wherein determining one or more pattern matches comprises determining an interface or artifact that matches a role of the user.

12. The computer-implemented method of claim 1, wherein the application interfaces are enterprise application programming interfaces.

13. The computer-implemented method of claim 1, wherein the application artifacts include one or more of a database, an executable program, a data file, a configuration file, a use case, a class diagram, a design model, a requirements document, a design document, a project plan, a business case, a risk assessment, a software build executable, a test plan, a walkthrough document, a test suite, a code library, a testing harnesses, or software documentation.

14. A non-transitory, computer-readable medium storing one or more instructions executable by a computer system to perform operations comprising:
accessing user information for a particular user;
accessing application interface and artifact information for application interfaces and artifacts that are available in an organization of the particular user;
determining one or more pattern matches between the user information and the application interface and artifact information;
generating one or more interface or artifact recommendations based on the determined one or more pattern matches; and
providing the one or more interface or artifact recommendations.

15. The non-transitory, computer-readable medium of claim 14, wherein the user information includes one or more of organizational data for the user, demographic data, interface or artifact usage information, a user role for the user, project participation data, user profile information, user activity data, user preferences, a current location of the user, or a current time at which a recommendation can be presented to the user.

16. The non-transitory, computer-readable medium of claim 14, wherein the application interface and artifact information includes one or more of an interface or artifact category, an interface or artifact description, interface or artifact knowledge prerequisite information, interface or artifact training prerequisite information, interface or artifact functionality, interface or artifact runtime requirements, interface or artifact configuration information, or interface or artifact permission requirements.

17. The non-transitory, computer-readable medium of claim 14, wherein at least one pattern match is a match between the user information and a predefined pattern relating to application interface and artifact data.

18. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
accessing user information for a particular user;
accessing application interface and artifact information for application interfaces and artifacts that are available in an organization of the particular user;
determining one or more pattern matches between the user information and the application interface and artifact information;
generating one or more interface or artifact recommendations based on the determined one or more pattern matches; and
providing the one or more interface or artifact recommendations.

19. The computer-implemented system of claim 18, wherein the user information includes one or more of organizational data for the user, demographic data, interface or artifact usage information, a user role for the user, project participation data, user profile information, user activity data, user preferences, a current location of the user, or a current time at which a recommendation can be presented to the user.

20. The computer-implemented system of claim 18, wherein the application interface and artifact information includes one or more of an interface or artifact category, an interface or artifact description, interface or artifact knowledge prerequisite information, interface or artifact training prerequisite information, interface or artifact functionality, interface or artifact runtime requirements, interface or artifact configuration information, or interface or artifact permission requirements.
